(19) United States
(12) Patent Application Publication
(10) Pub. No.: US 2006/0185179 A1
(43) Pub. Date: Aug. 24, 2006

(54) Adjustable dual marking device using marking spray paint

(76) Inventor: Richard Joseph St.Cyr, New Boston, NH (US)

Correspondence Address: Richard J. St.Cyr, 277 Chestnut Hill Rd, New Boston, NH, 03070, US

(21) Appl. No.: 11/352,897

(22) Filed: Feb. 13, 2006

Related U.S. Application Data
(60) Provisional application No. 60/654,879, filed on Feb. 22, 2005.

(51) Int. Cl. B43L 13/02

(52) U.S. Cl. 33/41.4

(57) ABSTRACT

An adjustable dual marker for marking areas on the ground. This device has a base two wheels and handle for easy movement. This marker uses spray marker paint cans that are inserted in paint can holders, which can be activated by a lever on the handle. The lever controls two cables that activate the nozzles on the paint cans. This marker is adjustable by means of two sliding rulers and is adjustable from approximately from three feet to six feet.

### CROSS-REFERENCE TO RELATED APPLICATIONS

This application claims the benefit of PPA Ser. No. 60/654,879

### FEDERALLY SPONSORED RESEARCH

Not Applicable

### SEQUENCE LISTING OR PROGRAM

Not Applicable

### BACKGROUND OF THE INVENTION-FIELD OF INVENTION

This invention relates to an improved method for marking curved areas on the ground such as, brick sidewalks, driveways, golf paths and other landscape projects. This device may also be useful in sporting events.

### BACKGROUND OF THE INVENTION

The advantage of this device is that this marking device makes two parallel lines using marking spray paint and is adjustable from approximately three feet to six feet. The prior art that I have researched makes only one line. This device is especially useful as it permits symmetrical outlining of curved areas such as, curved walkways and other projects requiring curves. With this device it is possible to outline a fifty foot walkway in one minute.

### BACKGROUND OF THE INVENTION-OBJECTS AND ADVANTAGES

Accordingly, besides the objects and advantages of the dual adjustable line marker described in my above patent, several objects and advantages of the present invention are:

(a) When used in marking curved areas this invention this devise is very fast it is possible to outline a fifty foot walkway in one minute, saving an individual much time.

(b) When outlining a curved area such as a walkway this device is adjustable from approximately three feet to six feet.

(c) An individual or contractor with my invention would be able to do the layout work on many projects and come back at a later date and complete the project.

(d) If changes on the outline of the project should be necessary, this can be accomplished very easily by using a different color marking paint.

Conclusion: This device is very fast for doing layout work on both straight and curved areas but especially the curved areas that need to be outlined prior to construction, such as sidewalks and driveways.

### SUMMARY OF THE INVENTION

In accordance with the present invention this adjustable dual marker has a frame which consists of, two wheels with an axle and a handle also a base plate above axle. On the base plate rest two sliding rulers which slide opposite of each other, at the end of each sliding ruler is a paint spray can holder which each hold a can of marking spray paint which can be be activated by means of a lever. When this lever is squeezed the two cables that are attached to the lever activate the discharge nozzles on the marking paint spray cans.

The marking paint spray cans are ideal for marking curved or straight parallel lines on various surfaces. The sliding rulers can be adjusted from approximately three feet to six feet. This invention is especially useful in marking curved areas such as sidewalks and driveways, However driveways would require two markings as the Design-A-Curve is only adjustable Up to six feet. This would still save much time for the installer.

### DRAWING-FIGURES

FIG. 1 Top view of adjustable dual marker.

FIG. 2 Bottom view of adjustable dual marker.

FIG. 3 Side view of adjustable dual marker.

FIG. 4 Top view of paint can holder and cable assembly.

FIG. 5 Bottom view of paint can holder and cable assembly.

FIG. 6 Side view of paint can holder.

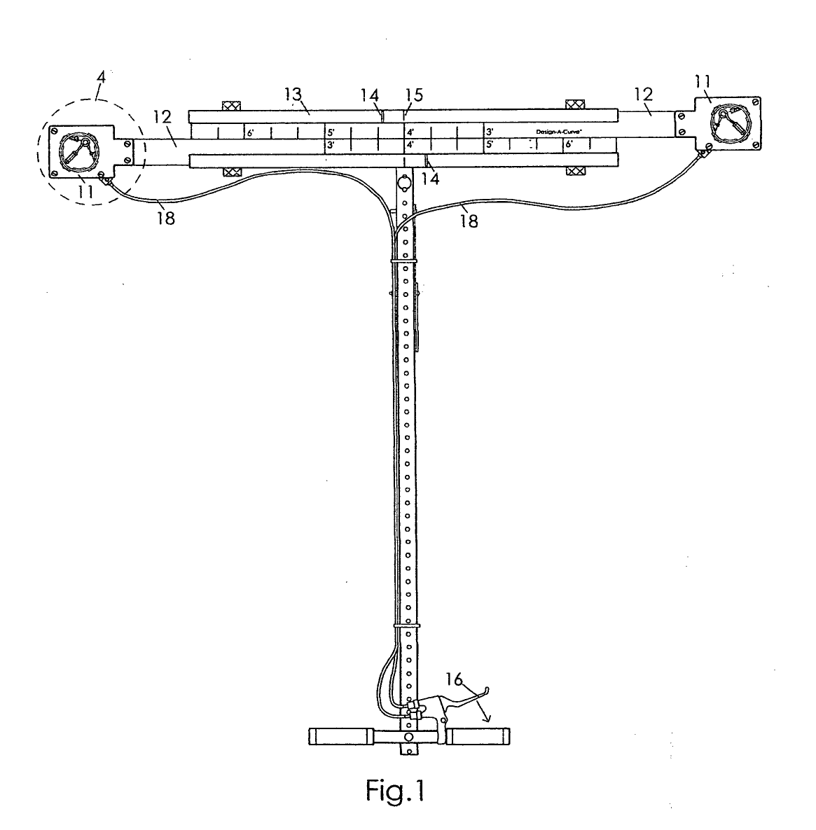

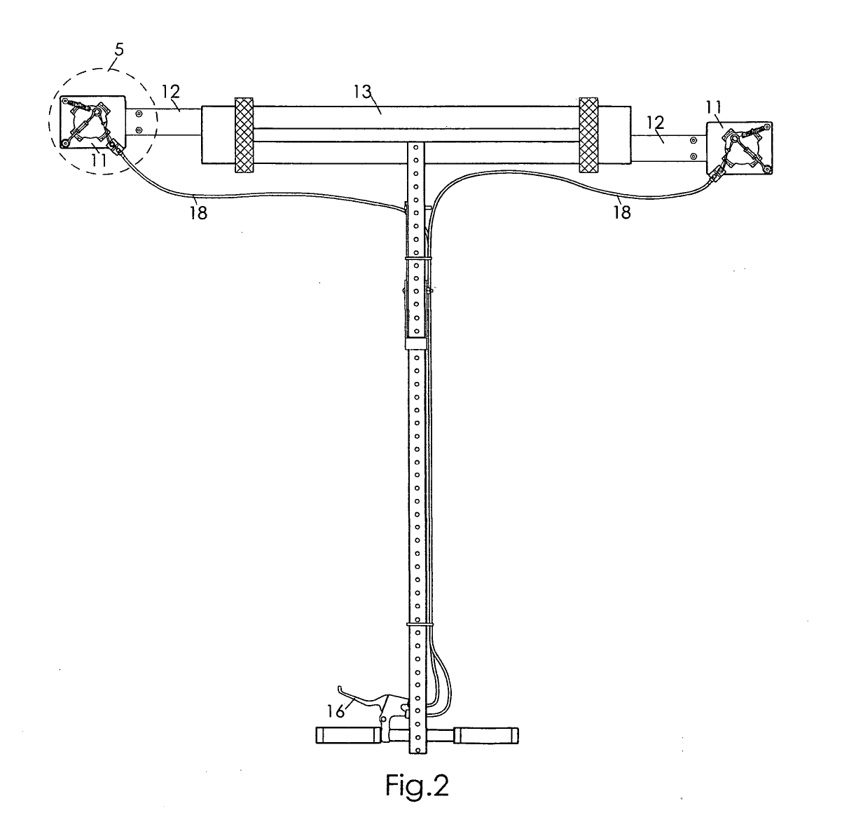

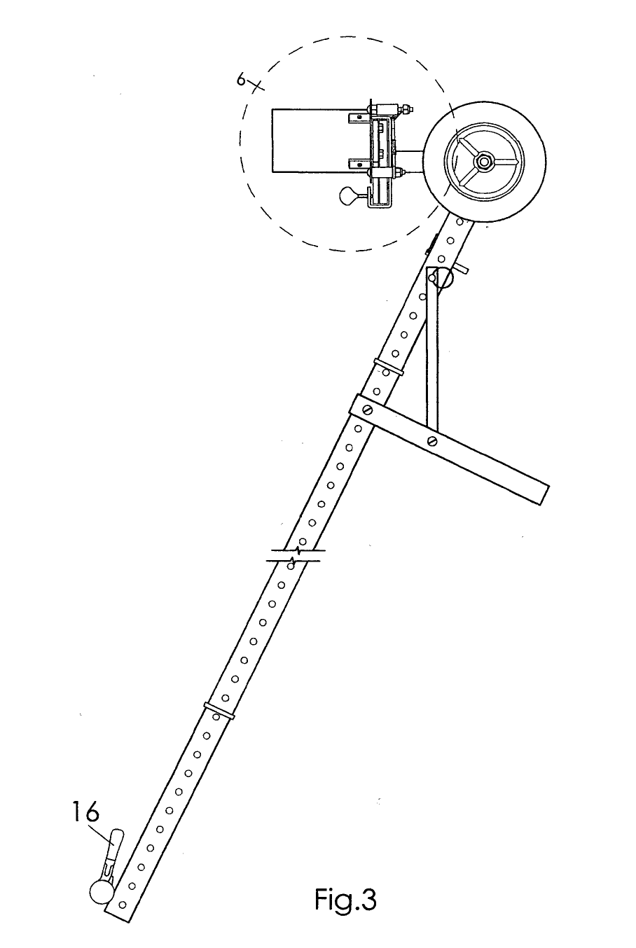

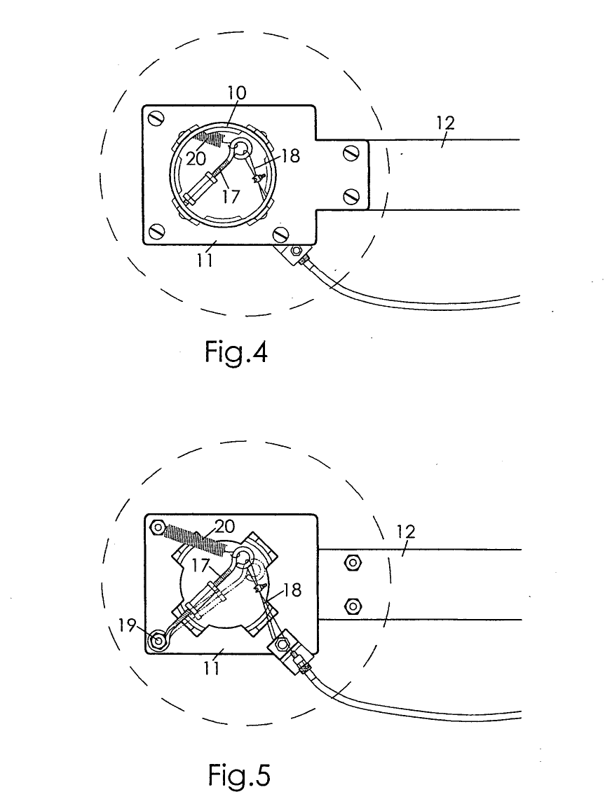

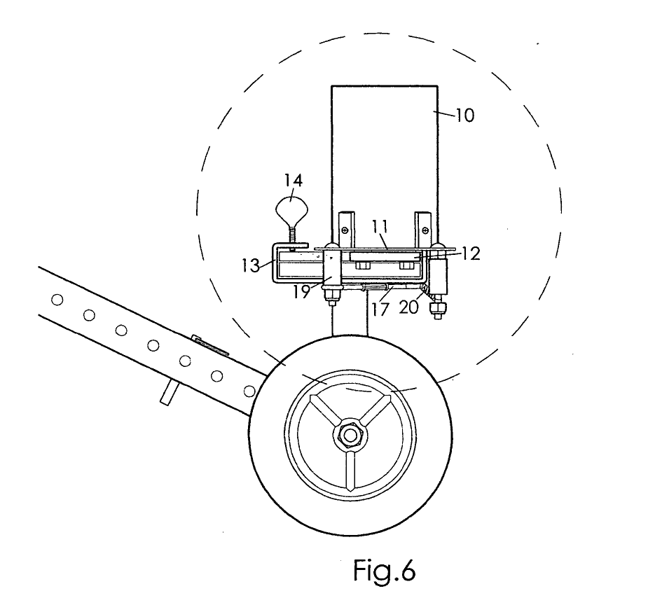

### DRAWINGS-REFERENCE NUMERALS

| | | | |
|---|---|---|---|
| 10 | Cylindrical can holders | 11 | Moveable arm with paint can holder |
| 12 | Moveable arms | 13 | One-piece track |
| 14 | Threaded thumbscrews | 15 | Center line |
| 16 | Control lever | 17 | Eyelets |
| 18 | Twin cables | 19 | Plastic spacer |
| 20 | Spring | | |

The Design-A-Curve device is used for marking curved or straight parallel lines on various surfaces. Line marking spray-paint cans (not shown) are used to make the markings. The spray cans are placed in cylindrical can holders (10) which are mounted to moveable arms (11). The operator then places the Design-A-Curve device at the beginning of the prospective area to be marked and centers cylindrical can holders (10) to mark each side of the desired path at the desired width.

The Design-A-Curve device is adjustable in width from approximately three feet to six feet by adjusting the moveable arms (12). The two moveable arms (12) slide on a base plate (13). Threaded thumbscrews (14) when tightened prevent the two moveable arms (12) from moving, which slide on a one piece track (13). In order to set a particular width, the operator simply selects the appropriate tick marks corresponding to the desired width on each moveable arm.

In order to begin marking the path or area to be marked, the operator squeezes the lever (16) which discharges the paint from the cans, and begins walking along the area to be marked. By squeezing the lever, the operator activates twin cables (18) attached to eyelets (17). The eyelets (17) are mounted to the moveable arms with paint can holder (11), and pivot on bolts and bushings which are anchored to the moveable arms with paint can holders (11). When the operator squeezes the lever (16), the twin cables (18) pull the eyelets (17) so that they push the discharge nozzles on the spray-paint cans (not shown) and discharge the paint. The eyelets are returned to their original position by means of a spring mechanism (20). When the eyelets (17) are pulled from the stationary position to the discharge position, the spring (20) is activated thus creating tension.

After marking the surface, the operator releases the control lever (16) to stop the discharge of paint. When the control lever (16) is released, the tension in the spring mechanism (20) causes the eyelets (17) to return to the stationary position.

According to the present invention, this dual adjustable marking device is a significant improvement over the single line markers, this device is especially useful and fast in marking curved areas.

I claim:

1. An adjustable dual marking device, comprising;
a frame with two wheels and a handle for moving said device;
frame has a flat base that holds two sliding rulers;
rulers have a paint spray can holder attached to each end of rulers;
the improvement wherein said marking device is adjustable and makes two lines.

2. The marking device of claim 1 has two wheels for movement on various surfaces.

3. The marking device of claim 2 has two sliding rulers inside a one piece track which is attached to frame.

4. The marking device of claim 3 has two inch increment markings on each ruler.

5. The marking device of claim 3 has two specially made spray paint can holders attached to each end of rulers.

6. The marking device of claim 3 has two thumb screws, one for each ruler to tighten rulers to base plate to make rulers stationary.

7. The marking device of claim 1 has a removable handle for easy storage.

8. The marking device of claim 2 is adjustable from approximately from three feet to six feet.

9. The marking device of claim 1 has a lever attached to handle that when squeezed controls two cables that are attached to paint can holders that activate paint can nozzles. Whereby this adjustable dual marking device is a significant improvement over existing marking devices, my research has shown single line markers whereas mine is an adjustable dual line marker and is especially useful in marking curved areas such as sidewalks.
